(19) United States
(12) Patent Application Publication
(10) Pub. No.: US 2023/0349539 A1
(43) Pub. Date: Nov. 2, 2023

(54) MOUNTING ADAPTER FOR A LUMINARIE AND RELATED MOUNTING METHODS

(71) Applicant: Atlas Lighting Products, Inc., Burlington, NC (US)

(72) Inventor: Ross Minty, Graham, NC (US)

(21) Appl. No.: 18/305,730

(22) Filed: Apr. 24, 2023

Related U.S. Application Data
(60) Provisional application No. 63/335,941, filed on Apr. 28, 2022.

(51) Int. Cl. F21V 21/08

(52) U.S. Cl. CPC F21V 21/08

(57) ABSTRACT

An adapter is provided for mounting of a luminaire having a luminaire fixture having a threaded knuckle mount stem to a mount surface. The adapter includes a base and a socket supported by the base that defines a first wireway through the base. The socket includes an upstanding sidewall that projects upwardly from the base that has a threaded bore configured to receive the threaded knuckle mount stem of the luminaire fixture. The base also includes a notch formed in the base that extends through a portion of the upstanding sidewall of the socket to form a second wireway in communication with the first wireway and a pair of apertures formed in the base and spaced laterally from the internally threaded socket on opposite sides of the base. The pair of apertures are configured to receive mounting hardware for attaching the adapter to the mount surface.

### CROSS-REFERENCE TO RELATED APPLICATION

The present application claims the filing benefit of U.S. Provisional Application Serial No. 63/335,941, filed Apr. 28, 2022, the disclosure of which is incorporated herein by reference in its entirety.

### FIELD OF THE INVENTION

The present invention relates generally to luminaires and, more particularly, to mounting of flood light luminaires.

### BACKGROUND OF THE INVENTION

Flood light luminaires, or flood luminaires, are known in the prior art for use in many commercial and industrial lighting applications, including outdoor applications such as for illuminating playing fields, parking lots, the exterior of a building, home, or other structure, or sporting events, for example. One well-known flood light luminaire known in the art is the Hawk light emitting diode (“LED”) flood light that is commercially available from the Applicant of the present application, Atlas Lighting Products, Inc., located in Burlington, North Carolina.

Flood light luminaires may be mounted to mount surfaces using a variety of mounting systems. Two common mounting systems used to mount a flood light luminaire to a mount surface is a trunnion mount and a knuckle mount. A trunnion mount is commonly used to attach a flood light luminaire to a flat mount surface, such as the ground, a stage, a rooftop, or a wall, for example. A knuckle mount is typically used to attach a flood light luminaire directly to an electrical fixture, such as conduit or a junction box, for example. The knuckle mount is generally used for smaller and lighter flood light luminaires. Once mounted, both the knuckle mount and the trunnion mount enable adjustment of the flood light luminaire to change direction of light emitting from the flood light luminaire. To this end, the Hawk flood light is available with both a knuckle mount or a trunnion mount.

There is a need in the industry for the ability to quickly adapt a flood light luminaire having a knuckle mount to a trunnion mount, or vice versa. In this regard, an end user may purchase a flood light luminaire having a knuckle mount, but realize at a later time that a trunnion mount is better suited for the specific mounting application. As a result, the end user would need to replace the flood light luminaire with a flood light luminaire having a trunnion mount. As another example, an end user may want to install a luminaire having a knuckle mount at a mount location where a luminaire was previously installed with a trunnion mount. In either case, there is a need to be able to quickly adapt a flood light luminaire having a knuckle mount to be mountable to a mount surface that would otherwise only be suitable for a trunnion-type mount in a cost-effective manner.

### SUMMARY OF THE INVENTION

The present invention overcomes the shortcomings and drawbacks of known approaches for adapting a flood light luminaire having a knuckle mount to a trunnion-style mount for mounting the luminaire to a mount surface. While the invention will be discussed in connection with certain embodiments, it will be understood that the invention is not limited to these embodiments. On the contrary, the invention includes all alternatives, modifications, and equivalents as may be included within the spirit and scope of the invention.

According to one exemplary embodiment, an adapter is provided for mounting of a luminaire having a luminaire fixture having a threaded knuckle mount stem to a mount surface. The adapter includes a base and a socket supported by the base that defines a first wireway through the base. The socket includes an upstanding sidewall that projects upwardly from the base that includes a threaded bore configured to receive the threaded knuckle mount stem of the luminaire fixture. The base also includes a notch formed in the base that extends through a portion of the upstanding sidewall of the socket to form a second wireway in communication with the first wireway and a pair of apertures formed in the base and spaced laterally from the internally threaded socket on opposite sides of the base. The pair of apertures are configured to receive mounting hardware for attaching the adapter to the mount surface.

A method of retrofitting a luminaire having a luminaire fixture including a threaded knuckle mount stem and a lighting source operatively connected to a bundle of electrical leads routed from the luminaire through the threaded knuckle mount stem to a trunnion mount for mounting the luminaire to a mount surface is provided. According to one embodiment of the present invention, the method comprises the steps of providing an adapter having a base, an internally threaded socket supported by the base that defines a first wireway through the base, and a pair of apertures formed in the base and spaced laterally from the internally threaded socket on opposite sides of the base. The method includes routing the bundle of electrical leads through the first wireway and mounting the luminaire to the adapter by threadedly coupling the threaded knuckle mount stem of the luminaire fixture to the internally threaded socket. The method further includes mounting the adapter to the mount surface by installing mounting hardware through the pair of apertures and into mount bores in the mount surface to secure the adapter and the luminaire to the mount surface.

According to another embodiment of the invention, an adapter is provided for mounting a luminaire having a luminaire fixture including a threaded knuckle mount stem to a mount surface. The adapter includes a base configured to engage the mount surface and a socket supported by the base that defines a first wireway through the base. The socket includes an upstanding sidewall that projects upwardly from the base and includes a threaded bore configured to threadably receive the threaded knuckle mount stem of the luminaire fixture for coupling the luminaire to the adapter. The adapter further includes a notch formed in the base that extends through a portion of the upstanding sidewall of the socket to form a second wireway in communication with the first wireway and a pair of apertures formed in the base and spaced laterally from the internally threaded socket on opposite sides of the base. The pair of apertures is configured to receive mounting hardware for attaching the adapter to the mount surface.

A method of replacing a first luminaire mounted to a mount surface, the first luminaire having a luminaire fixture including a trunnion mount, with a second luminaire having a luminaire fixture including a threaded knuckle mount stem and a lighting source operatively connected to a bundle of electrical leads routed from the luminaire through the threaded knuckle mount stem is provided. According to one embodiment of the present invention, the method comprises the steps of providing an adapter including a base, an internally threaded socket supported by the base that defines a first wireway through the base, and a pair of apertures formed in the base and spaced laterally from the internally threaded socket on opposite sides of the base. The method includes disconnecting and removing the first luminaire from the mount surface to expose a pair of mount bores formed in the mount surface and attaching the adapter to the second luminaire. Attaching the adapter to the second luminaire includes routing the bundle of electrical leads through the first wireway and mounting the second luminaire to the adapter by threadedly coupling the threaded knuckle mount stem of the luminaire fixture to the internally threaded socket. The method further includes attaching the adapter to the mount surface by installing mounting hardware through the pair of apertures and into engagement with the pair of mount bores in the mount surface to secure the adapter and the second luminaire to the mount surface. To this end, the pair of mount bores were previously used to secure the first luminaire to the mount surface.

Various additional features and advantages of the invention will become more apparent to those of ordinary skill in the art upon review of the following detailed description of the illustrative embodiments taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an exemplary prior art trunnion mount for mounting a flood light luminaire to a mount surface, such as an exterior of a building.

FIG. 2 is a disassembled view of an adapter for use with a flood light luminaire having a knuckle mount in accordance with an embodiment of the present invention.

FIG. 2A is an enlarged view of the adapter of FIG. 2.

FIG. 3 illustrates the flood light secured to the mount surface with the adapter of FIG. 2, illustrating a bundle of electrical leads extending from the adapter.

FIG. 4 is a partial cross-sectional view of the connection between the knuckle mount of the flood light luminaire and the adapter in accordance with an embodiment of the present invention.

### DETAILED DESCRIPTION OF THE INVENTION

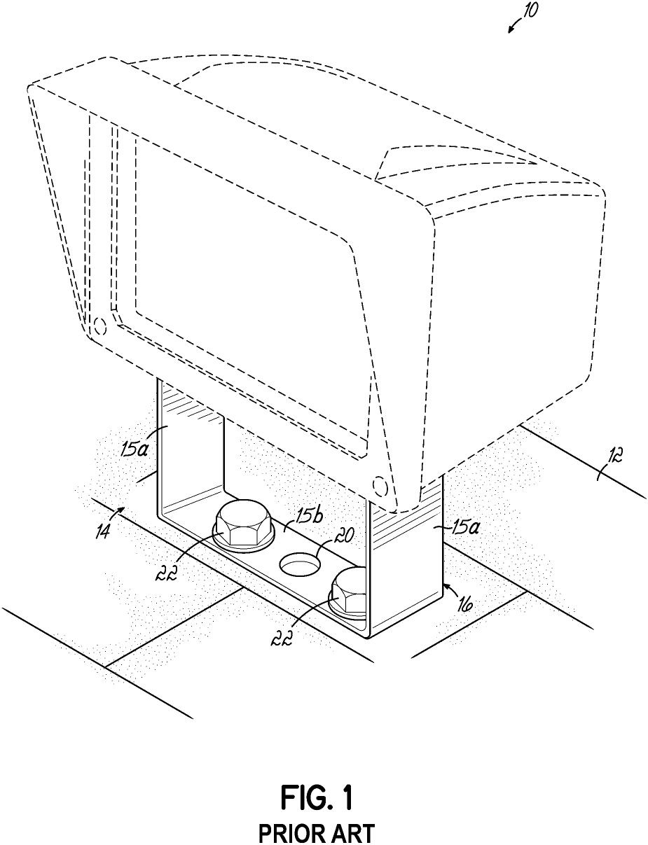

Referring now to the figures, and to FIG. 1 in particular, an exemplary flood light luminaire 10 (“luminaire”) is shown mounted to a generally flat mount surface 12, such as an exterior of a building, for example, with a well-known and widely used trunnion mount 14. The trunnion mount 14 includes a generally U-shaped surface mounting bracket 16 coupled to the flood light luminaire 10. The exemplary trunnion mount 14 includes a pair of upstanding legs 15a spaced apart and which are each connected to opposite ends of an interconnecting web or base portion 15b. The mounting bracket 16, in particular the pair of upstanding legs 15a, may be rotatably coupled to the luminaire 10 such that the luminaire 10 is rotatable about the surface mounting bracket 16 to adjust a position of the luminaire 10 to thereby change the direction of light emission, for example. As shown, the surface mounting bracket 16 includes the base portion 15b configured to be attached to the mount surface 12. The base portion 15b includes a conduit aperture 20 for receiving electrical leads therethrough, for example, and a pair of apertures (not shown) configured to receive mounting hardware 22 for mounting the trunnion mount 14 and the flood light luminaire 10 to the mount surface 12, as shown. The mounting hardware 22 may be in the form of screws, bolts, or any other suitable coupling devices, for example.

For various reasons, a need may arise to replace the trunnion-mounted flood light luminaire 10 shown in FIG. 1 with a replacement luminaire having a knuckle mount. However, a conventional knuckle mount is typically not configured to be mounted directly to a flat mount surface, such as the mount surface 12 shown in FIG. 1. In this regard, embodiments of the present invention are directed to an adapter for quickly retrofitting, or adapting, a luminaire having a knuckle mount so that the luminaire is capable of being mounted to a generally flat mount surface that would ordinarily require the use of a conventional trunnion mount, or has a trunnion-mounted luminaire currently mounted to the mount surface. These and other benefits of the adapter of the present invention are described in further detail below.

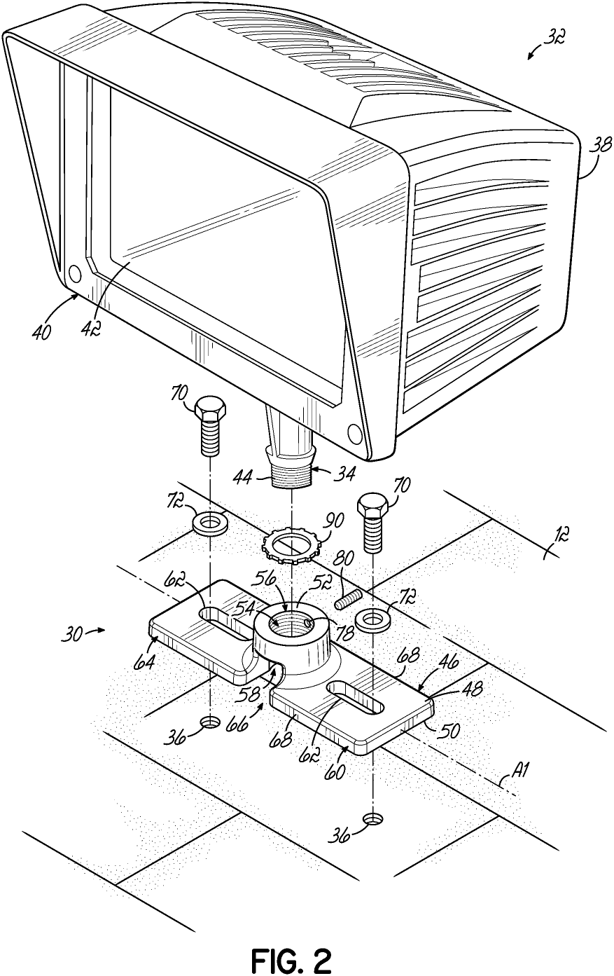

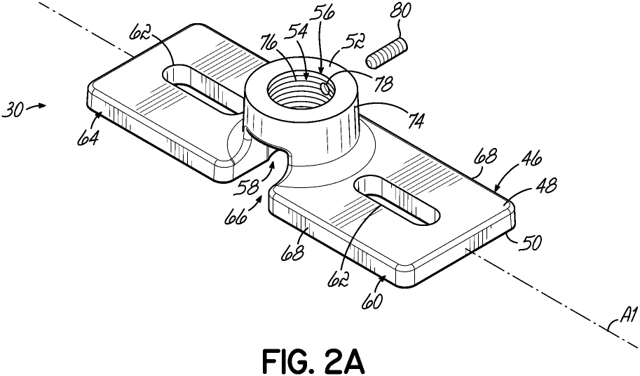

Referring now to FIGS. 2-4, an adapter 30 and a method of retrofitting, or adapting, a flood light luminaire 32 (“luminaire”) having a knuckle mount 34 according to one embodiment of the present invention is shown and will now be described in additional detail. According to one embodiment, the trunnion-mounted flood light luminaire 10 shown in FIG. 1 may be replaced with the flood light luminaire 32 having the knuckle mount 34 shown in FIG. 2 using the adapter 30. In this regard, the adapter 30 is mountable to both the knuckle mount 34 of the flood light luminaire 32 and to the mount surface 12. More particularly, the adapter 30 is capable of being mounted to the mount surface 12 using a same pair of mount bores 36 previously used to secure the trunnion-mounted luminaire 10 of FIG. 1 to the mount surface 12. To this end, it is possible to reuse the mounting hardware 22 to attach the adapter 30 and thus the luminaire 32 having the knuckle mount 34 to the mount surface 12. In another embodiment, the adapter 30 may be used to adapt the luminaire 32 having the knuckle mount 34 for mounting to any generally flat mount surface, for example, whether or not a luminaire was previously mounted to the mount surface 12. To this end, the drawings are not intended to be limiting.

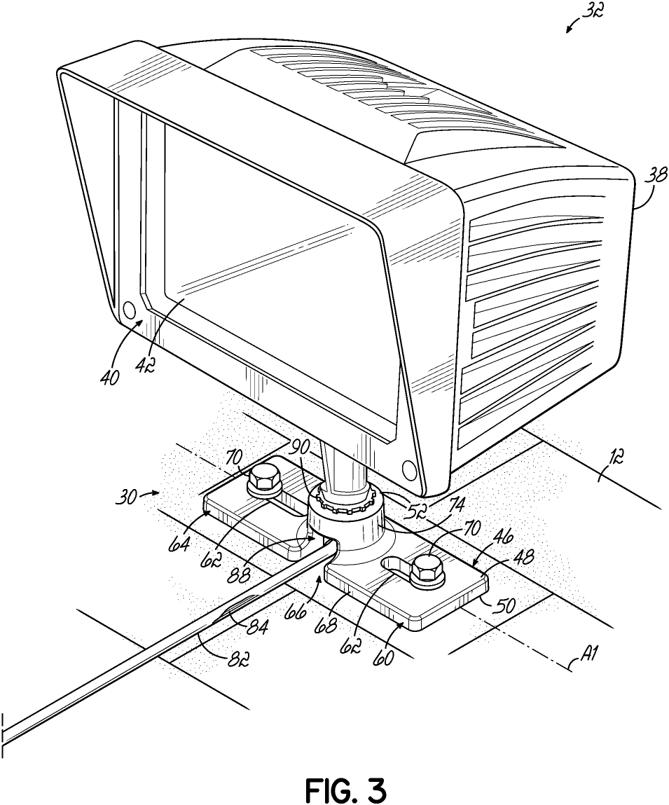

The exemplary flood light luminaire 32 shown in FIGS. 2-4 is a Hawk flood light that is commercially available from the Applicant of the present application, Atlas Lighting Products, Inc. As best shown in FIGS. 2 and 3, the flood light luminaire 32 includes a fixture 38 and a lens assembly 40 coupled to the fixture 38 to enclose a light source (not shown), such as an array of LED’s, within an optical chamber of the flood light luminaire 32. The lens assembly 40 includes a lens 42 which may be formed of glass or transparent plastic, such as an optical grade polycarbonate or acrylic, for example. The fixture 38 houses electrical components such as a driver or ballast, and other components known by those skilled in the art to operate the flood light 32 of the type described herein. The knuckle mount 34 is attached to the luminaire fixture 38 and includes a threaded knuckle mount stem 44 that extends from a base of the fixture 38. To this end, the knuckle mount 34 may permit rotational movement of the flood light luminaire 32 about the threaded knuckle mount stem 44 through a rotational joint (not shown) so that a position of the luminaire 32 may be adjusted to thereby change the direction of light emission, for example.

With reference to FIGS. 2 and 2A, the adapter 30 includes a generally plate-like base 46 having a first side 48, an opposite second side 50 configured to engage the mount surface 12, and an internally threaded socket 52 supported by the base 46 that defines a first wireway 54 extending through the base 46. As shown, the first wireway 54 extends between a first opening 56 located on the first side 48 of the base 46 and a second opening 58 located on the second side 50 of the base 46. The base 46 further includes a first leg 60 having a first mounting aperture 62, a second leg 64 having a second mounting aperture 62, and a notch 66. As described in further detail below, the notch 66 is configured to receive a bundle of electrical leads, or electrical cord, to electrically connect the flood light luminaire 32 to a source of power.

As shown, the pair of apertures 62 are formed in the base 46 and spaced laterally from the internally threaded socket 52 so as to be located on opposite sides of the base 46. In the embodiment shown, the internally threaded socket 52 is located directly between the first aperture 62 and the second aperture 62 along a longitudinal axis A1 of the base 46. However, other configurations of the pair of apertures 62 are possible, such as a catty-corner configuration or a configuration where both apertures 62 are located closer to a lengthwise edge 68 of the base 46 so as to be offset from the longitudinal axis A1, for example.

As shown, the pair of apertures 62 are each elongated along the longitudinal axis A1 of the base 46 to define a slot. The slot configuration of the apertures 62 provides the adapter 30 with adjustability for various lateral spacing ranges of mount bores 36 in the mount surface 12, as well as lateral adjustability of the adapter 30 along the mount surface 12, for example. Each aperture 62 is configured to receive appropriate mounting hardware, such as a bolt 70 and a washer 72 combination, for example, for attaching the adapter 30 to the mount surface 12. To this end, the mounting hardware may be in the form of screws, bolts with our without washers, or any other suitable coupling devices, for example.

The internally threaded socket 52 is positioned between the first leg 60 and the second leg 64 of the base 46 and is configured to receive the threaded knuckle mount stem 44 for coupling the luminaire 32 to the adapter 30. The internally threaded socket 52 includes an upstanding sidewall 74 that projects upwardly from the first side 48 of the base 46. As shown, the upstanding sidewall 74 includes a first threaded bore 76 and a second threaded bore 78. The first threaded bore 76 defines the first opening 56 to the first wireway 54 and is configured to threadably receive the threaded knuckle mount stem 44 of the luminaire 32 for coupling the luminaire 32 to the adapter 30. The second threaded bore 78 extends through the upstanding sidewall 74 of the socket 52 and is configured to threadably receive a set screw 80 therethrough for preventing rotation of the threaded knuckle mount stem 44 of the luminaire 32 relative to the adapter 30.

In the embodiment of the adapter 30 shown, the upstanding sidewall 74 is annular in transverse cross-section. However, the upstanding sidewall 74 may have other transverse cross-sectional shapes, such as square, hexagonal, or any other polygonal shape, for example. In one embodiment, the threaded bore 76 is configured to receive the threaded knuckle mount stem 44 which includes a ½ inch threaded connection having 14 threads per inch (i.e., ½-14), according to the National Standard Taper Pipe Threads (“NPT”) size chart, for example. However, it will be understood by a person skilled in the art that the threaded bore 76 may have other size and thread count configurations to accommodate other connection configurations, such as a ¾-14 or a ⅜-18 NPT connection configurations, for example.

As shown in FIGS. 2-4, the adapter 30 includes the notch 66 formed in the base 46 according to one embodiment for receiving a bundle of electrical leads 82 comprising one or more wires 84 operatively connected to the luminaire 32. As shown, the notch 66 is located generally between the first leg 60 and the second leg 64 of the base 46 and extends from one lengthwise edge 68 of the base 46 through a portion of the upstanding sidewall 74 of the socket 52 to intersect the second opening 58 to the first wireway 54. More particularly, the opening formed in the upstanding sidewall 74 by the notch 66 defines a second wireway 88 that is in communication with the first wireway 54. In this regard, an axis of the second wireway 88 is generally transverse to an axis of the first wireway 54. The dual wireway 54, 88 configuration of the adapter 30 provides several options for routing the bundle of electrical leads 82 from the adapter 30 to a power source (not shown), as described in further detail below.

Having described the adapter 30 according to embodiments of the present invention, a process of replacing a first, trunnion-mounted flood light luminaire 10 with a second, flood light luminaire 32 having a knuckle mount 34 using the adapter 30 according to one embodiment of the present invention will now be described in additional detail in connection with FIGS. 1-4. In this regard, the process begins by first disconnecting and removing the first, trunnion-mounted luminaire 10 from the mount surface 12, which includes removing the mounting hardware 22 from the mounting bracket 16. This also includes removing the trunnion-mounted luminaire 10 and trunnion mount 14 from the mount surface 12 to expose the mount bores 36. Once the first luminaire 10 has been removed, the second luminaire 32 may be mounted to the mount surface 12, as described below.

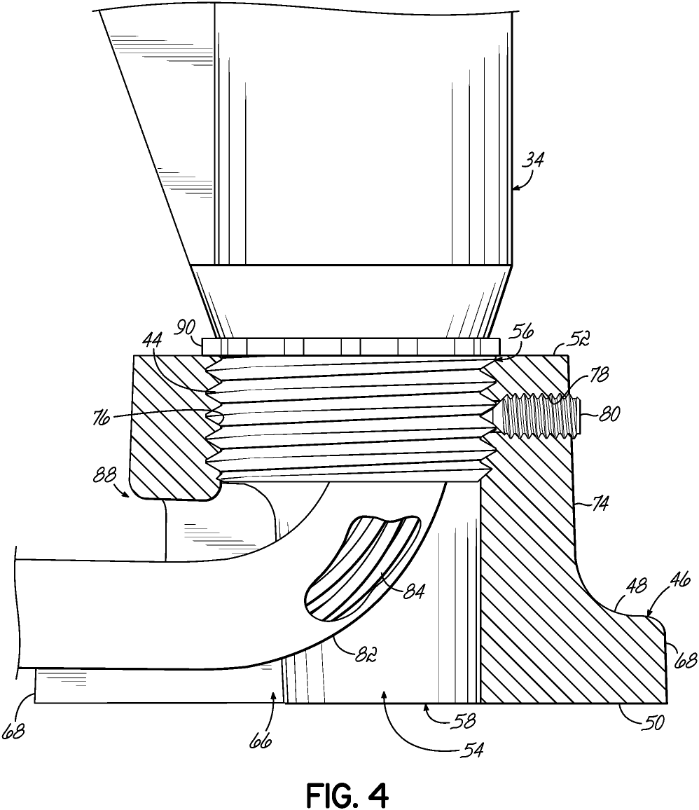

Either before the first luminaire 10 is removed, during, or after removal, the adapter 30 is to be attached to the second luminaire 32. The adapter 30 is mounted to the second luminaire 32 by first routing the bundle electrical leads 82 through the first wireway 54 and through the adapter 30. Next, the adapter 30 is attached to the luminaire 32 by inserting the threaded knuckle mount stem 44 into the threaded bore 76 of the socket 52 and rotating the adapter 30 and/or luminaire 32 to threadedly couple the adapter 30 to the threaded knuckle mount stem 44 of the luminaire 32. The threaded knuckle mount stem 44 is prevented from rotating relative to the socket 52 of the adapter 30 by threading the set screw 80 through the bore 78 in the upstanding sidewall 74 and into engagement with the threaded knuckle mount stem 44 of the luminaire 32, as shown in FIG. 4. In this regard, the set screw 80 prevents the threaded knuckle mount stem 44 from inadvertently unthreading from the socket 52. Lastly, assembly of the adapter 30 to the luminaire 32 may optionally include a lock nut 90 to improve the connection between the luminaire 32 and the adapter 30. If used, the lock nut 90 is threadedly coupled to the threaded mount stem 44 before the adapter 30 is attached. Once the adapter 30 has been attached, the lock nut 90 is then tightened against the socket 52 of the adapter 30. To this end, the lock nut 90 may be in addition to the set screw 80, or used as an alternative.

With the adapter 30 attached to the luminaire 32, the adapter 30 and luminaire 32 assembly may then be attached to the mount surface 12. In this regard, mounting the adapter 30 to the mount surface 12 includes engaging the second side 50 of the adapter 30 with the mount surface 12, aligning the apertures 62 of the adapter 30 over the mount bores 36, and installing mounting hardware 70 through each aligned aperture 62 and mount bore 36 to secure the adapter 30 and luminaire 32 assembly to the mount surface 12, as shown in FIG. 3.

As shown in FIGS. 3-4, the bundle of electrical leads 82 is routed through the first wireway 54 and the second wireway 88 and out from the adapter 30 through the notch 66. In the embodiment shown, the bundle of electrical leads 82 is freely routed from the adapter 30 to an electrical source (not shown), such as a junction box, for example. However, if required by local electrical codes, for example, the bundle of electrical leads 82 may be routed from the adapter 30 directly into electrical conduit to be connected to an electrical source. As best shown in FIG. 4, the bundle of electrical leads 82 is routed from the threaded knuckle mount stem 44, through the first wireway 54 and the second wireway 88, and ultimately out from the adapter 30 and along the mount surface 12 to an appropriate electrical source.

In an alternative embodiment, the bundle of electrical leads 82 may be routed directly through the first wireway 54 and out from the adapter 30 through the second opening 58 to the first wireway 54. This wiring configuration would be appropriate for a mount surface that includes a conduit aperture for receiving the bundle of electrical leads 82, for example. In this regard, the adapter 30 would be mounted to the mount surface with the first wireway 54 generally aligned over the conduit aperture so that the bundle of electrical leads 82 may be routed directly through the first wireway 54 and into the conduit aperture. Thus, depending on the configuration of a mount surface, the bundle of electrical leads 82 may either be routed (1) directly through the first wireway 54 and out from the adapter 30 through the second opening 58 to the first wireway 54 or (2) through the first wireway 54 and the second wireway 88 and out from the adapter 30 via the notch 66.

While various aspects in accordance with the principles of the invention have been illustrated by the description of various embodiments, and while the embodiments have been described in considerable detail, they are not intended to restrict or in any way limit the scope of the invention to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. An adapter for mounting a luminaire having a luminaire fixture including a threaded knuckle mount stem to a mount surface, the adapter comprising:
a base configured to engage the mount surface;
an internally threaded socket supported by the base that defines a first wireway through the base, the internally threaded socket being configured to receive the threaded knuckle mount stem to couple the luminaire to the adapter; and
a pair of apertures formed in the base and spaced laterally from the internally threaded socket on opposite sides of the base, the pair of apertures being configured to receive mounting hardware to attach the adapter to the mount surface.

2. The adapter of claim 1, wherein the internally threaded socket comprises an upstanding annular sidewall that projects upwardly from the base and includes a first threaded bore configured to threadably receive the threaded knuckle mount stem of the luminaire fixture to couple the threaded knuckle mount stem of the luminaire fixture to the adapter.

3. The adapter of claim 2, wherein the upstanding annular sidewall includes a second threaded bore configured to threadably receive a set screw therethrough to prevent rotation of the threaded knuckle mount stem of the luminaire fixture relative to the adapter.

4. The adapter of claim 2, further comprising a notch formed in the base that extends through a portion of the upstanding annular sidewall of the internally threaded socket to form a second wireway in communication with the first wireway.

5. The adapter of claim 1, wherein the first wireway extends between a first opening located on a first side of the base and a second opening located on a second side of the base.

6. The adapter of claim 5, further comprising a notch formed in the base that extends through a portion of the internally threaded socket to form a second wireway in communication with the first wireway.

7. The adapter of claim 6, wherein the notch intersects the second opening to the first wireway.

8. The adapter of claim 1, wherein the base includes a first leg and a second leg with the internally threaded socket being located between the first leg and the second leg.

9. The adapter of claim 8, wherein the pair of apertures includes a first aperture formed in the first leg and a second aperture formed in the second leg.

10. The adapter of claim 9, wherein the first aperture and the second aperture are each elongated to comprise a slot.

11. The adapter of claim 9, wherein the internally threaded socket is located directly between the first aperture and the second aperture along a longitudinal axis of the base.

12. The adapter of claim 10, wherein the first aperture and the second aperture are elongated along a longitudinal axis of the base.

13. The adapter of claim 8, further comprising a notch formed in the base that extends through a portion of the internally threaded socket to form a second wireway in communication with the first wireway, the notch being located between the first leg and the second leg.

14. A method of retrofitting a luminaire having a luminaire fixture including a threaded knuckle mount stem and a lighting source operatively connected to a bundle of electrical leads routed from the luminaire through the threaded knuckle mount stem to a trunnion mount for mounting the luminaire to a mount surface, the method comprising:
providing an adapter comprising a base, an internally threaded socket supported by the base that defines a first wireway through the base, and a pair of apertures formed in the base and spaced laterally from the internally threaded socket on opposite sides of the base;
routing the bundle of electrical leads through the first wireway;
mounting the luminaire to the adapter by threadedly coupling the threaded knuckle mount stem of the luminaire fixture to the internally threaded socket; and
mounting the adapter to the mount surface by installing mounting hardware through the pair of apertures and into mount bores in the mount surface to secure the adapter and the luminaire to the mount surface.

15. The method of claim 14, wherein the internally threaded socket further comprises an upstanding annular sidewall that projects upwardly from the base and includes a first threaded bore and a second threaded bore configured to threadably receive a set screw therethrough, the method further comprising:
securing the luminaire to the adapter by threading a set screw through the second threaded bore formed in the upstanding annular sidewall and into engagement with the threaded knuckle mount stem of the luminaire fixture.

16. The method of claim 14, wherein the adapter further comprises a notch formed in the base that extends through a portion of the internally threaded socket to form a second wireway in communication with the first wireway, the method further comprising:
routing the bundle of electrical leads through the first wireway and the second wireway.

17. The method of claim 14, wherein the luminaire comprises a flood light.

18. An adapter for mounting a luminaire having a luminaire fixture including a threaded knuckle mount stem to a mount surface, the adapter comprising:
a base configured to engage the mount surface;
a socket supported by the base that defines a first wireway through the base, the socket includes an upstanding sidewall that projects upwardly from the base and includes a threaded bore configured to threadably receive the threaded knuckle mount stem of the luminaire fixture for coupling the luminaire to the adapter;
a notch formed in the base that extends through a portion of the upstanding sidewall of the socket to form a second wireway in communication with the first wireway; and
a pair of apertures formed in the base and spaced laterally from the internally threaded socket on opposite sides of the base, the pair of apertures being configured to receive mounting hardware for attaching the adapter to the mount surface.

19. A method of replacing a first luminaire mounted to a mount surface, the first luminaire having a luminaire fixture including a trunnion mount, with a second luminaire having a luminaire fixture including a threaded knuckle mount stem and a lighting source operatively connected to a bundle of electrical leads routed from the luminaire through the threaded knuckle mount stem, comprising:
providing an adapter comprising a base, an internally threaded socket supported by the base that defines a first wireway through the base, and a pair of apertures formed in the base and spaced laterally from the internally threaded socket on opposite sides of the base;
disconnecting and removing the first luminaire from the mount surface to expose a pair of mount bores formed in the mount surface;
attaching the adapter to the second luminaire, the steps comprising:
routing the bundle of electrical leads through the first wireway; and
mounting the second luminaire to the adapter by threadedly coupling the threaded knuckle mount stem of the luminaire fixture to the internally threaded socket; and
attaching the adapter to the mount surface by installing mounting hardware through the pair of apertures and into engagement with the pair of mount bores in the mount surface to secure the adapter and the second luminaire to the mount surface, wherein the pair of mount bores were previously used to secure the first luminaire to the mount surface.

20. The method of claim 19, wherein the first luminaire and the second luminaire are each a flood light luminaire.
